(19) United States
(12) Patent Application Publication
(10) Pub. No.: US 2011/0022277 A1
(43) Pub. Date: Jan. 27, 2011

(54) Voice Activated Snow Plow Control

(76) Inventor: Aaron Michael Pugh, (US)

Correspondence Address: Aaron Michael Pugh, 915 2nd St. E, Hastings, MN, 55033, US

(21) Appl. No.: 12/509,432

(22) Filed: Jul. 24, 2009

(51) Int. Cl. G06F 19/00

(52) U.S. Cl. 701/50

(57) ABSTRACT

A voice activated snow plow control that is both a safe and efficient means for plowing snow with a vehicle mounted snow plow. A laptop computer is connected to a headset and has voice recognition software installed that will control an application which is provided for the voice activated snow plow control. There is a rectangular box, the control module, which houses a microcontroller, a group of relays, and various discrete electrical components such as resistors, diodes, and transistors, which is connected to the laptop computer using, but is not limited to, rs232 serial communication. There is firmware provided for the microcontroller that controls the relays in the control module. The relays then connect to the existing snow plow's manual joystick control to simulate the joystick's snow plow control, which move the snow plow in the desired direction.

### RELATED APPLICATIONS

The present application is related to U.S. Pat. No. RE38665, issued Dec. 7, 2004, for WIRELESS SNOW PLOW CONTROL SYSTEM, by Struck et al., included by reference herein.

The present application is related to U.S. Pat. No. 6,964,121, issued Nov. 15, 2005, for ALL TERRAIN VEHICLE MOUNT ASSEMBLY FOR A UTILITARIAN ACCESSORY, by Gary Harris, included by reference herein.

The present application is related to U.S. Pat. No. 7,096,163, issued Aug. 22, 2006, for VOICE ACTIVATED COMMANDS IN A BUILDING CONSTRUCTION DRAWING SYSTEM, by Joseph P. Reghetti, included by reference herein.

The present application is related to U.S. Pat. No. 7,171,366, issued Jan. 30, 2007, for METHOD AND APPARATUS FOR VOICE-ACTIVATED CONTROL OF ATTACHMENT OF CONSTRUCTION MACHINE, by Hideto Furuta, included by reference herein.

### FIELD OF THE INVENTION

The present invention relates to a voice activated snow plow control and, more particularly, to controlling a snow plow with human voice commands.

### BACKGROUND OF THE INVENTION

The voice activated snow plow control is an invention that will make plowing snow easier and more efficient for the driver, and safer for both the driver and the general public. Until now, a snow plow operator had to drive, shift, and operate the snow plow simultaneously with the use of his or her hands which was both difficult and dangerous. The voice activated snow plow control alleviates the problem of controlling the snow plow's joystick by hand and lets the operator give voice commands to control all of the snow plow's movements. This applies not only to individuals plowing snow, but could have amazing commercial appeal for city and state snow plows.

### SUMMARY OF THE INVENTION

In accordance with the present invention, there is provided a voice activated snow plow control that is both a safe and efficient means for plowing snow with a vehicle mounted snow plow. A laptop computer is connected to a headset and has voice recognition software installed that will control an application that is provided for the voice activated snow plow control. There is a rectangular box, the control module, which houses a microcontroller, a group of relays, and various discrete electrical components such as resistors, diodes, and transistors, that is connected to the laptop computer using, but not limited to, rs232 serial communication. There is provided firmware for the microcontroller that controls the relays in the control module. The relays then connect to the existing snow plow's manual joystick control to simulate the joystick's snow plow control, which move the snow plow in the desired direction.

It would be advantageous to provide a voice activated control for a snow plow.

It would also be advantageous to provide a voice activated control for a snow plow that would make plowing snow safer.

It would further be advantageous to provide a voice activated control for a snow plow that would make plowing snow more efficient.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a voice activated snow plow control;

FIG. 2 is a front view of a laptop computer with a microphone jack for the headset required to give voice commands and a laptop db-9 male connector to connect the laptop computer to the rs232 to tt1 converter;

FIG. 4 is a rear view of a laptop computer with an available rs232 serial communication port db-9 male connector;

FIG. 5 is a front view of a rs232 to tt1 converter connected to the laptop computer by the rs232 to tt1 converter db-9 female connector used to convert the high voltage levels of the rs232 protocol to the 0 volt and 5 volt levels of the tt1 protocol;

FIG. 3 is a front view of a control module with the 6-pin connector and control box db-9 female connector;

FIG. 6 is a rear view of a rs232 to tt1 converter connected to the control module by the rs232 to tt1 converter db-9 male connector used to convert the high voltage levels of the rs232 protocol to the 0 volt and 5 volt levels of the tt1 protocol;

FIG. 7 is a front view of a joystick used to control the existing snow plow which is connected to the control module using, but not limited to, the 6-pin connector;

FIG. 8 is a front view of a headset to give voice commands to the laptop computer and connects to the microphone jack on the laptop computer;

FIG. 9 is a top view of a microcontroller housed in the control module which is connected to the relays and control module db-9 female connector; and

FIG. 10 is a top view of a group of relays housed in the control module that control the solenoid valves of the snow plow and are wired to the 6-pin connector and the microcontroller.

For purposes of clarity and brevity, like elements and components will bear the same designations and numbering throughout the Figures.

### DESCRIPTION OF THE PREFERRED EMBODIMENT

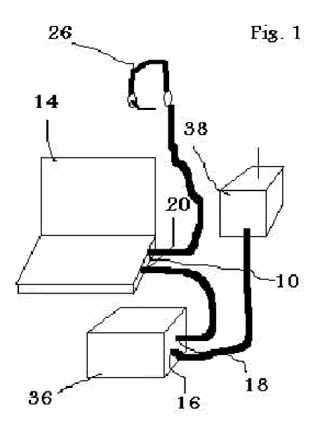

FIG. 1 is a front view of a voice activated snow plow control 40 used for controlling a snow plow with voice commands rather than the operator needing to use their hands.

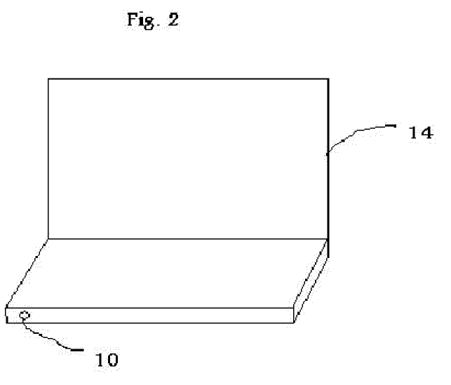

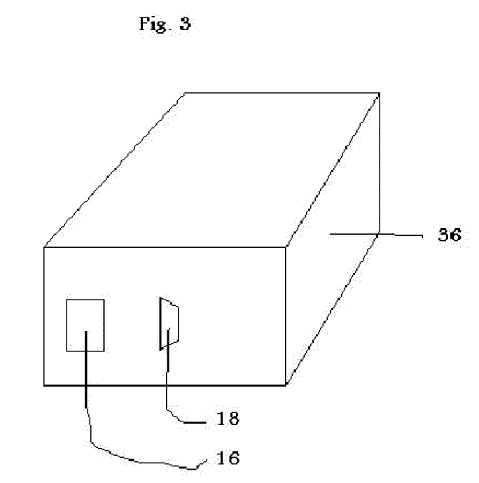

FIG. 2 is a front view of a laptop computer 14 with a microphone jack 10 for the headset 26 required to give voice commands and a laptop male connector 20 to connect the laptop computer 14 to the rs232 to tt1 converter 34.

Laptop computer 14 will have a voice recognition software program installed to translate spoken language into commands that will push buttons on a secondary computer program which will send information to the control module 36 out of the laptop computer 14 serial port.

Control module 36 deciphers information that the laptop computer 14 has sent and triggers relays 32 to control the snow plow's solenoid valves, creating movement.

FIG. 3 is a front view of a control module 36 with the 6-pin connector 16 and control module db-9 female connector 18.

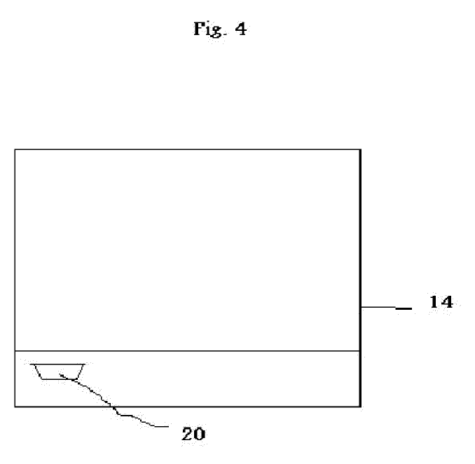

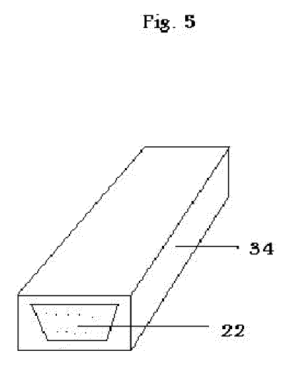

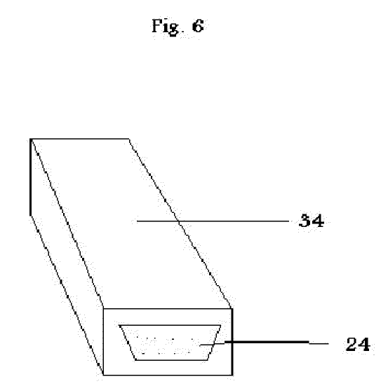

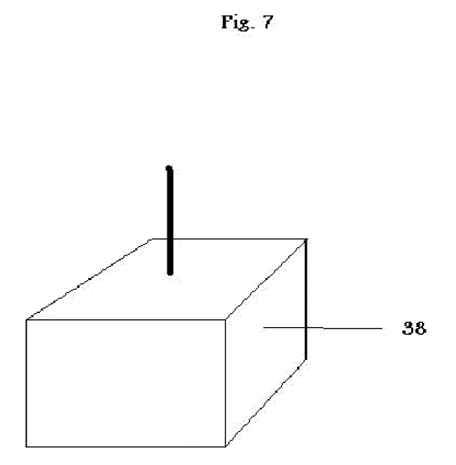

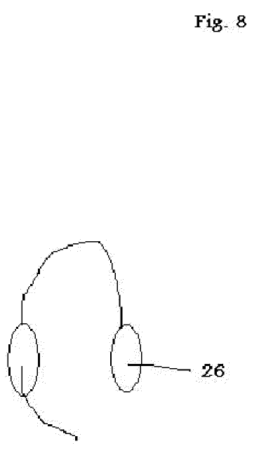

FIG. 4 is a rear view of a laptop computer 14 with an available serial port laptop db-9 male connector 20 set up for 9600 baud, 8 data bits, 1 stop bit, and no parity.

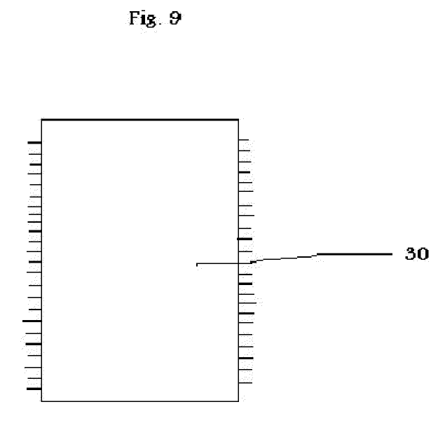

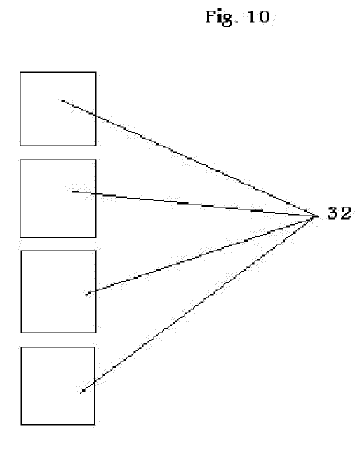

FIG. 5 is a front view of an rs232 to tt1 converter 34 connected to the laptop computer 14 by the rs232 to tt1 converter db-9 female connector 22 used to convert the high voltage levels of rs232 to the 0 volt and 5 volt levels of tt1 protocol.

FIG. 6 is a rear view of an rs232 to tt1 converter 34 connected to the laptop computer 14 by the rs232 to tt1 converter db-9 male connector 24 used to convert the high voltage levels of rs232 to the 0 volt and 5 volt levels of tt1 protocol.

FIG. 7 is a front view of a joystick 38 used to control the existing snow plow which connects to the control module 36.

FIG. 8 is a front view of a headset 26 which connects to the microphone jack 10 required to give voice commands connected to the laptop computer 14.

FIG. 9 is a top view of a microcontroller 30 housed in the control module 36.

Microcontroller 30 is used to translate data from the laptop computer 14 into electrical signals to relays 32 controlling hydraulic solenoid valves moving the snow plow in the desired direction.

FIG. 10 is a top view of a group of four relays 32 housed in the control module 36 that control the solenoid valves of the snow plow.

Thus, in summary, it can be seen that what is provided in this invention is a voice activated snow plow control 40 that is both a safe and efficient means for plowing snow with a vehicle mounted snow plow. A rectangular box, the control module 36, houses a circuit board on which a microcontroller 30, 4 electromechanical relays 32, and various discrete components such as resistors, diodes, and transistors are mounted. There is provided a laptop db-9 male connector 20 to connect a laptop computer 14 with an available serial port to an rs232 to tt1 converter db-9 female connector 22 on the rs232 to tt1 converter 34. There is also provided an rs232 to tt1 converter db-9 male connector 24 on the rs232 to tt1 converter 34 used to connect to the control module 36 on which the control module db-9 female connector 18 is mounted. There is provided a 6-pin connector 16 on the control module 36 to connect the existing snow plow's joystick 38 to the control module 36.

The Voice activated snow plow control 40 was designed to plow snow for the individual snow plow operator for their own vehicle, in practice; of course, it would not be unusual for the voice activated snow plow control 40 to be found in a commercial snow plowing environment.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A voice activated snow plow control for safely and efficiently controlling an apparatus for plowing snow, comprising:
means for connecting the headset to the laptop computer for voice control;
means for receiving voice commands via a microphone, sending information to the control module based on the voice command received, and receiving information from the control module verifying the voice command was translated correctly, internally connected to said means for connecting the headset to the laptop computer for voice control;
means for connecting the existing snow plow's joystick to the control module;
means for connecting the rs232 converter to the control module;
means for connecting the laptop computer to the rs232 to tt1 converter, internally connected to said means for receiving voice commands via a microphone, sending information to the control module based on the voice command received, and receiving information from the control module verifying the voice command was translated correctly;
means for connecting the laptop computer to the rs232 to tt1 converter, flexibly connected to said means for connecting the laptop computer to the rs232 to tt1 converter;
means for connecting the rs232 to tt1 converter to the control module, rigidly connected to said means for connecting the rs232 converter to the control module;
means for connecting the headset into the laptop computer, flexibly connected to said means for connecting the headset to the laptop computer for voice control;
means for receiving signals from and sending signals to the laptop computer and controlling the relays, rigidly connected to said means for connecting the rs232 converter to the control module;
means for controlling the hydraulic solenoid valves of the snow plow, internally connected to said means for receiving signals from and sending signals to the laptop computer and controlling the relays, and internally connected to said means for connecting the existing snow plow's joystick to the control module;
means for converting the high voltage levels of the rs232 protocol to the 0 volt and 5 volt levels of the tt1 protocol, internally connected to said means for connecting the rs232 to tt1 converter to the control module, and internally connected to said means for connecting the laptop computer to the rs232 to tt1 converter;
means for housing the microcontroller, relays, control module db-9 female connector, and the 6-pin connector;
means for controlling the snow plow manually, flexibly connected to said means for connecting the existing snow plow's joystick to the control module; and
means for controlling a snow plow with voice commands rather than the operator using his or her hands.

2. The voice activated snow plow control in accordance with claim 1, wherein said means for connecting the headset to the laptop computer for voice control comprises a microphone jack.

3. The voice activated snow plow control in accordance with claim 1, wherein said means for receiving voice commands via a microphone, sending information to the control module based on the voice command received, and receiving information from the control module verifying the voice command was translated correctly comprises a laptop computer.

4. The voice activated snow plow control in accordance with claim 1, wherein said means for connecting the existing snow plow's joystick to the control module comprises a 6-pin connector.

5. The voice activated snow plow control in accordance with claim 1, wherein said means for connecting the rs232 converter to the control module comprises a control module db-9 female connector.

6. The voice activated snow plow control in accordance with claim 1, wherein said means for connecting the laptop computer to the rs232 to tt1 converter comprises a laptop db-9 male connector.

7. The voice activated snow plow control in accordance with claim 1, wherein said means for connecting the laptop computer to the rs232 to tt1 converter comprises an rs232 to tt1 converter db-9 female connector.

8. The voice activated snow plow control in accordance with claim 1, wherein said means for connecting the rs232 to tt1 converter to the control module comprises an rs232 to tt1 converter db-9 male connector.

9. The voice activated snow plow control in accordance with claim 1, wherein said means for connecting the headset into the laptop computer comprises a headset.

10. The voice activated snow plow control in accordance with claim 1, wherein said means for receiving signals from and sending signals to the laptop computer and controlling the relays comprises a microcontroller.

11. The voice activated snow plow control in accordance with claim 1, wherein said means for controlling the hydraulic solenoid valves of the snow plow comprises a relays.

12. The voice activated snow plow control in accordance with claim 1, wherein said means for converting the high voltage levels of the rs232 protocol to the 0 volt and 5 volt levels of the tt1 protocol comprises an rs232 to tt1 converter.

13. The voice activated snow plow control in accordance with claim 1, wherein said means for housing the microcontroller, relays, control module db-9 female connector, and the 6-pin connector comprises a control module.

14. The voice activated snow plow control in accordance with claim 1, wherein said means for controlling the snow plow manually comprises a joystick.

15. The voice activated snow plow control in accordance with claim 1, wherein said means for controlling a snow plow with voice commands rather than the operator using his or her hands comprises a voice activated snow plow control.

16. A voice activated snow plow control for safely and efficiently controlling an apparatus for plowing snow, comprising:
a microphone jack, for connecting the headset to the laptop computer for voice control;
a laptop computer, for receiving voice commands via a microphone, sending information to the control module based on the voice command received, and receiving information from the control module verifying the voice command was translated correctly, internally connected to said microphone jack;
a 6-pin connector, for connecting the existing snow plow's joystick to the control module;
a control module db-9 female connector, for connecting the rs232 converter to the control module;
a laptop db-9 male connector, for connecting the laptop computer to the rs232 to tt1 converter, internally connected to said laptop computer;
a rs232 to tt1 converter db-9 female connector, for connecting the laptop computer to the rs232 to tt1 converter, flexibly connected to said laptop db-9 male connector;
a rs232 to tt1 converter db-9 male connector, for connecting the rs232 to tt1 converter to the control module, rigidly connected to said control module db-9 female connector;
a headset, for connecting the headset into the laptop computer, flexibly connected to said microphone jack;
a microcontroller, for receiving signals from and sending signals to the laptop computer and controlling the relays, rigidly connected to said control module db-9 female connector;
a relays, for controlling the hydraulic solenoid valves of the snow plow, internally connected to said microcontroller, and internally connected to said 6-pin connector;
a rs232 to tt1 converter, for converting the high voltage levels of the rs232 protocol to the 0 volt and 5 volt levels of the tt1 protocol, internally connected to said rs232 to tt1 converter db-9 male connector, and internally connected to said rs232 to tt1 converter db-9 female connector;
a control module, for housing the microcontroller, relays, control module db-9 female connector, and the 6-pin connector;
a joystick, for controlling the snow plow manually, flexibly connected to said 6-pin connector; and
a voice activated snow plow control, for controlling a snow plow with voice commands rather than the operator using his or her hands.

17. A voice activated snow plow control for safely and efficiently controlling an apparatus for plowing snow, comprising:
a microphone jack, for connecting the headset to the laptop computer for voice control;
a laptop computer, for receiving voice commands via a microphone, sending information to the control module based on the voice command received, and receiving information from the control module verifying the voice command was translated correctly, internally connected to said microphone jack;
a 6-pin connector, for connecting the existing snow plow's joystick to the control module;
a control module db-9 female connector, for connecting the rs232 converter to the control module;
a laptop db-9 male connector, for connecting the laptop computer to the rs232 to tt1 converter, internally connected to said laptop computer;
a rs232 to tt1 converter db-9 female connector, for connecting the laptop computer to the rs232 to tt1 converter, flexibly connected to said laptop db-9 male connector;
a rs232 to tt1 converter db-9 male connector, for connecting the rs232 to tt1 converter to the control module, rigidly connected to said control module db-9 female connector;
a headset, for connecting the headset into the laptop computer, flexibly connected to said microphone jack;
a microcontroller, for receiving signals from and sending signals to the laptop computer and controlling the relays, rigidly connected to said control module db-9 female connector;
a relays, for controlling the hydraulic solenoid valves of the snow plow, internally connected to said microcontroller, and internally connected to said 6-pin connector;
a rs232 to tt1 converter, for converting the high voltage levels of the rs232 protocol to the 0 volt and 5 volt levels of the tt1 protocol, internally connected to said rs232 to tt1 converter db-9 male connector, and internally connected to said rs232 to tt1 converter db-9 female connector;
a control module, for housing the microcontroller, relays, control module db-9 female connector, and the 6-pin connector;
a joystick, for controlling the snow plow manually, flexibly connected to said 6-pin connector; and
a voice activated snow plow control, for controlling a snow plow with voice commands rather than the operator using his or her hands.
